(19) United States
(12) Patent Application Publication
(10) Pub. No.: US 2007/0200849 A1
(43) Pub. Date: Aug. 30, 2007

(54) Graphic device and control method thereof

(75) Inventor: Yi-Peng Chen, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: VIA Technologies Inc.

(21) Appl. No.: 11/390,936

(22) Filed: Mar. 28, 2006

(30) Foreign Application Priority Data
Feb. 24, 2006 (TW) 95106275

(51) Int. Cl. G06T 15/50

(52) U.S. Cl. 345/426

(57) ABSTRACT

An apparatus of a graphic system is provided. The graphic system consists of a first graphic device and a second graphic device. The first graphic device has a clip and setup processor and a pixel shader. The clip and setup processor accesses and clips the graphic data. The pixel shader pixel shades the clipped graphic data. The second graphic device is included in the first graphic device besides the clip and setup processor and the pixel shader. The second graphic device has a first vertex shader to generate the previously mentioned graphic data. The first vertex shader performs coordinate transformation and lighting on the vertex data.

### BACKGROUND OF THE INVENTION

1. Field of the Invention

This invention relates to an apparatus and a control method of a graphic device, more specifically to a cost saving and performance improving apparatus and control method of a graphic device.

2. Description of the Related Art

As the complexity and the vividness of graphic application increases, computer platform keeps on improving performances, for example processing speed of the microprocessor, system memory capacity and bandwidth. To meet the requirement of modem graphic application, the graphic device (or the graphic accelerator) has become a part of the integrated components in modem computer system.

FIG. 1 illustrates a diagram of a prior art graphic system 10 using an add-on graphic card. The graphic system 10 consists of a control chip set 14, a system memory 16 and an add-on graphic card 18. The graphic data is transmitted from a central processing unit (CPU) 12 to the graphic card 18 through the control chip set 14 and a bus interface 13. The bus interface 13 may be an accelerated graphics port (AGP) or a peripheral component interconnect (PCI). The graphic card 18 has a local memory 19 to store the graphic data and graphic commands.

FIG. 2 illustrates a graphic processing pipeline of an add-on graphic card 18. The graphic processing pipeline includes receiving the graphic vertex data from a CPU 12 through a bus interface 13 and performing coordinate transformation and lighting on the vertex data in step S22. In step S24 the coordinate transformed and lighting processed graphic vertex data is received and performed with clipping. The clipped graphic vertex data is then pixel shaded and the graphic data is outputted to display on the monitor in the step S26.

Though conventional graphic cards connect to the system as add-on cards, recently more and more computers integrate the graphic system onto the motherboard. The graphic system is integrated by embedding the graphic card in the control chip set of an integrated chip set, and combining the local memory in the conventional system memory. Such integrated memory architecture is referred to unified memory architecture (UMA). FIG. 3 is a diagram of a prior art graphic system 30 utilizing an integrated graphic chip. The graphic system 30 consists of an integrated chip set 33 and a system memory 36. The graphic task of the graphic system 30 is transmitted from a CPU 12 directly to the integrated chip set 33.

The graphic processing of the integrated graphic chip 331 in the integrated chipset 33 is the same as the graphic processing pipeline shown in FIG. 2. But notice that the size of the integrated graphic chip 331 is controlled by reducing the gate number of the integrated graphic chip 331. Therefore the vertex shader of the integrated graphic chip 331 in the integrated chip set 33 computes and processes the graphic data through the CPU 12. As a result the processing efficiency is lower than the general vertex shader implemented by hardware, for example the add-on graphic card. Many customers choose to add another add-on graphic card to the computer in addition. The system BIOS (basic input output system) of the computer will disable the integrated graphic chip 331 in the integrated chip set 33 to prevent disturbance to the add-on graphic card. Consequently the integrated graphic chip 331 is wasted. Therefore a graphic system is required to solve the balancing of the system performance and cost.

### SUMMARY

To address the above deficiencies, an embodiment of the present invention provides a graphic system consisting of a first graphic device and a second graphic device. The first graphic device consists of a clip and setup processor and a pixel shader. The clip and setup processor accesses and clips the graphic data, and the pixel shader performs pixel shading on the clipped graphic data. The second device is disposed removably in the first graphic device besides the clip and setup processor and the pixel shader. The second graphic device has a first vertex shader to perform coordinate transformation and lighting on the vertex data and output the above mentioned graphic data.

Another embodiment of the present invention is a control method of a graphic system to control a first device and a second device. The first device has a first vertex shader and the second device has a second vertex shader. Herein the second vertex shader performs coordinate transformation and lighting on the vertex data by a CPU. The graphic control method includes detecting the above mentioned first graphic device, distributing the vertex data to the first vertex shader and the second vertex shader by a driver, and generating a graphic data by performing coordinate transformation and lighting on the previous vertex data by the first vertex shader.

### BRIEF DESCRIPTION OF THE DRAWINGS

These and other features, objects and advantages of the present invention will be better understood with regard to the following description and accompanying drawings where:

FIG. 1 is a diagram of the prior art graphic system utilizing an add-on graphic card.

FIG. 2 is a flowchart of a graphic processing pipeline.

FIG. 3 is a diagram of the prior art graphic system utilizing an integrated graphic chip.

FIG. 4 is a preferred diagram of the graphic system of an embodiment in the present invention.

FIG. 5 is a diagram respective to the integrated graphic chip and the add-on graphic chip illustrated in FIG. 4.

FIG. 6 is a flowchart of the graphic control method of an embodiment in the present invention.

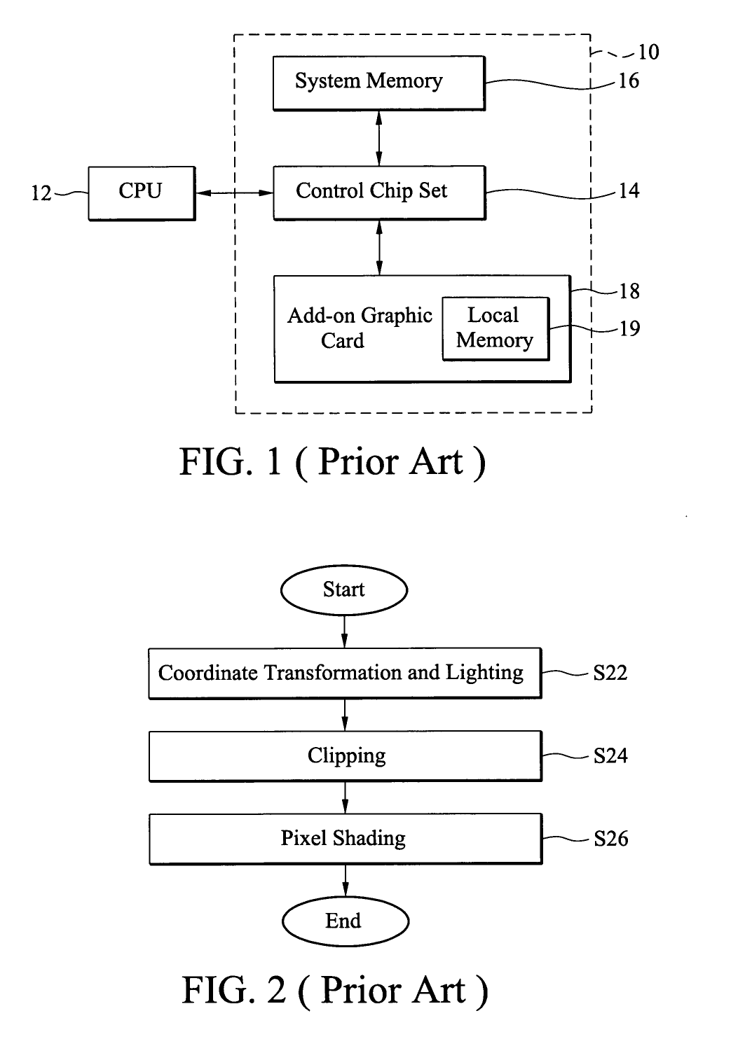

### DETAILED DESCRIPTION

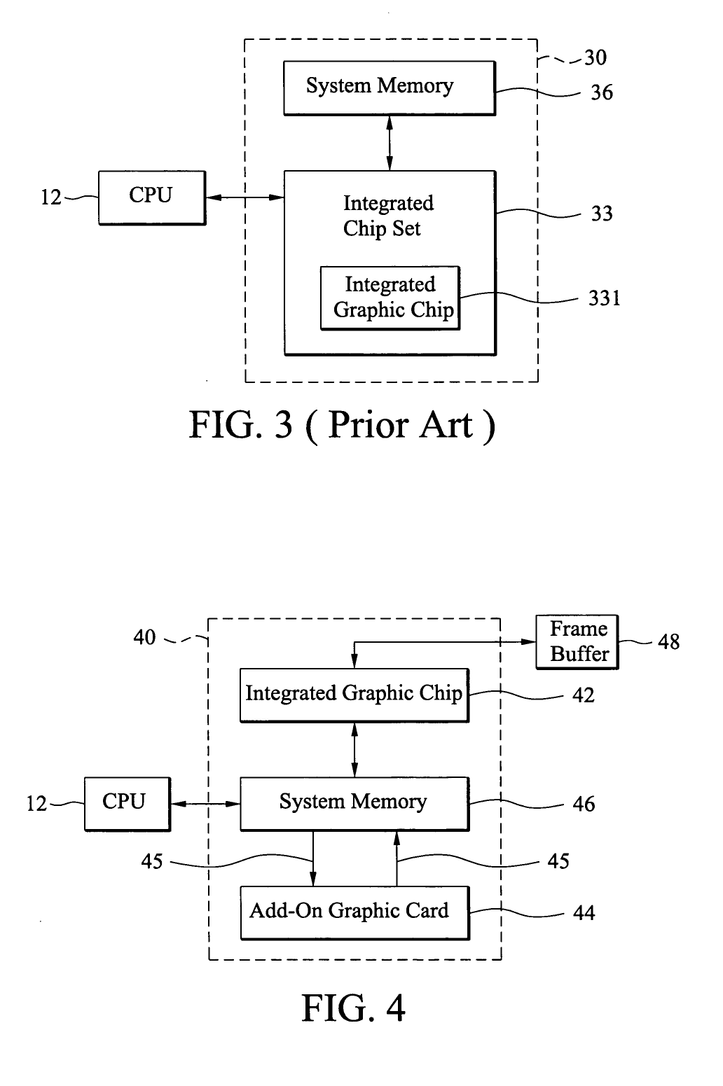

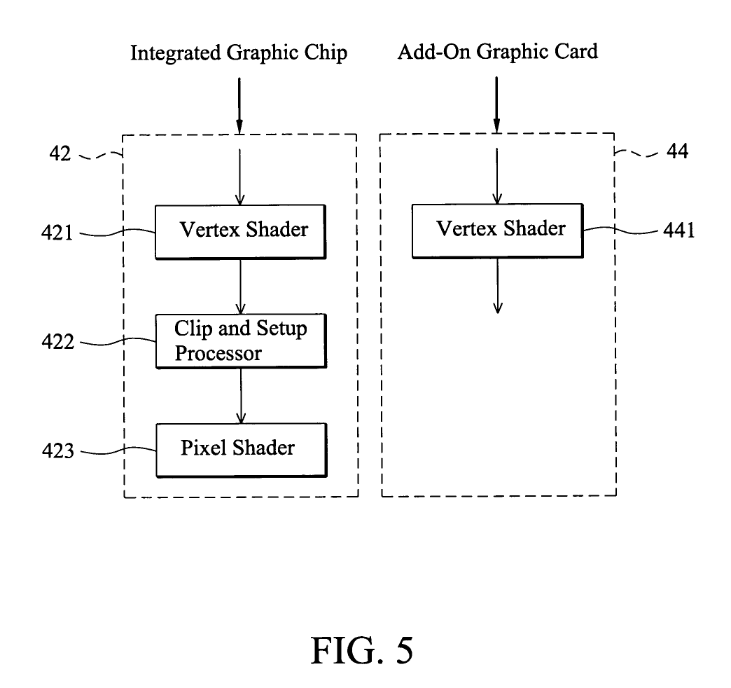

FIG. 4 is a preferred diagram of a graphic system in the present invention. The graphic system 40 consists of an integrated graphic chip 42, an add-on graphic card 44 and a system memory 46. The system memory 46 may be different types of integrated circuit memory (ex, SRAM, DRAM or cache memory). FIG. 5 illustrates the graphic processing of an integrated graphic chip 42 and an add-on graphic card 44 in the graphic system 40. As shown in FIG. 5 the graphic processing of the integrated graphic chip 42 is the same as the graphic processing pipeline described in FIG. 2. The integrated graphic chip 42 consists of a vertex shader 421, a clip and setup processor 422 and a pixel shader 423. The vertex shader 421 performs coordinate transformation and lighting as described in step S22 of FIG. 2. The clip and setup processor 422 performs clipping as described in step S24 of FIG. 2. The pixel shader 423 performs pixel shading as described in step S26 of FIG. 2. Herein the vertex shader 421 processes the graphic data by a CPU 12. The add-on graphic card 44 only has a vertex shader 441 to perform coordinate transformation and lighting in step S22 of FIG. 2 and is implemented by hardware. The benefit is the efficiency can be improved better by utilizing integrated circuits (ICs), application specific ICs rather than utilizing the CPU 12 which has lower processing speed than the add-on graphic card 44 specialized in graphic data processing. The add-on graphic card 44 is disposed removably in the integrated graphic chip 42. Therefore the processing of the graphic system 40 without the add-on graphic card 44 is the same as the prior art graphic system 30 utilizing an integrated graphic chip as shown in FIG. 3. A system BIOS will detect the presence of the add-on graphic card 44 and a driver will distribute the vertex data to the vertex shaders 441 and 421 to perform coordinate transformation and lighting. The vertex data is distributed respectively to the vertex shader 441 of the add-on graphic card 44 and the vertex shader 421 of the integrated graphic chip 42 according to previous computation record of the CPU 12. For example, the processing time ratio between the vertex shaders 421 and 441 is 3:2, each respective to the integrated graphic chip 42 processing by the CPU 12 and the add-on graphic card 44. A packet of 20 vertex data is distributed in the ratio 2:3 to the vertex shaders 421 and 441, i.e. 8 vertex data to the vertex shader 421 in the integrated graphic chip 42 and 12 vertex data to the vertex shader 441 in the add-on graphic card 44. Therefore the vertex data can be dynamically distributed to the vertex shaders 421 and 441 according to the computation capability of the CPU 12 and the add-on graphic card 44, and the coordinate transformation and lighting can be processing by two vertex shaders at the same time. The vertex computation efficiency can be improved in the graphic system 40 than the conventional independent integrated graphic chip or the independent add-on graphic card. In addition, previous processing record of the add-on graphic card 44 found by the system BIOS is referenced in vertex data distribution combined with the record of the CPU 12. If the computation capability of the CPU 12 is found to be zero, the driver will send all the vertex data to the vertex shader 441 of the add-on graphic card 44. Conclude from the above description, the graphic system 40 of the present invention can dynamically distribute vertex data in an optimal ratio between vertex shader 421 and 441 to either both or one of the two vertex shaders by a driver. Herein optimal ratio is determined by the computation capability of the CPU 12 and the add-on graphic card 44. The graphic data is transmitted from the CPU 12 to the integrated graphic chip 42 and the system memory 46. The add-on graphic card 44 accesses the vertex data from the system memory 46 through a peripheral component interconnect (PCI) or a PCI express, and stores back the coordinate transformed and lighting processed vertex data in the system memory 46. The clip and setup processor 422 accesses the vertex shader 441 from the system memory 46 to perform coordinate transformation and lighting on the vertex data and then clips the vertex data. The clipped graphic data is pixel shaded by the pixel shader 423 and the shaded graphic data is sent to a frame buffer 48 to display on the monitor.

In graphic system 40 the add-on graphic card 44 simply comprises the vertex shader 441 without a clip and setup processor or a pixel shader. Therefore the graphic system in the present invention has the advantage of cost down comparing with conventional add-on graphic card with clip and setup processor and pixel shader.

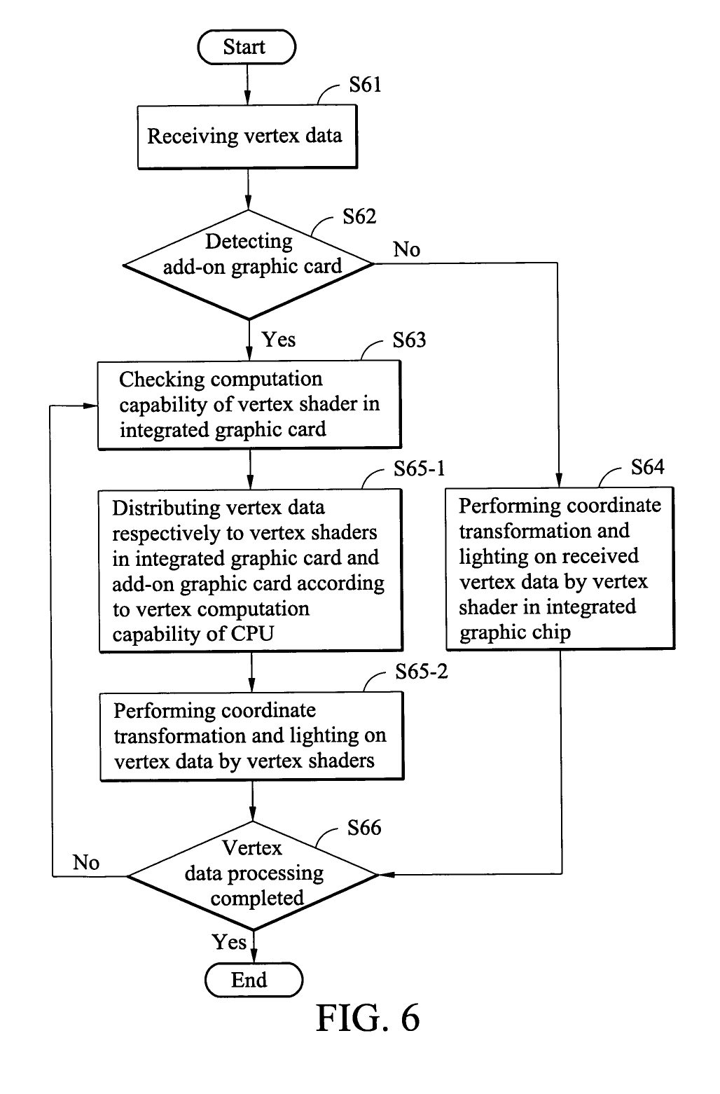

FIG. 6 is a flowchart of a graphic control method in the present invention. The graphic control method is used to control an integrated graphic chip and an add-on graphic card. The graphic processing of the integrated graphic chip is the same as the graphic processing pipeline in FIG. 2 and the vertex shader herein also processes graphic data through a CPU. The add-on graphic card only has a vertex shader as shown in FIG. 2, and is implemented by hardware and disposed removably in the integrated graphic chip. In step S61 of the graphic control method 60, the vertex data is received. In step S62 detect the presence of an add-on graphic card. If yes go to step S63, otherwise go to step S64. Herein step S64 the received vertex data is transmitted to the vertex shader in the integrated graphic chip to perform coordinate transformation and lighting and generate a graphic data. In step S63, determining the vertex computation capability of the CPU and, if necessary, the add-on graphic card according to previous record and go to step S65. In step S65 the received vertex data is distributed to the vertex shaders in the integrated graphic chip and the add-on graphic card according to the result of step S63 and is performed with coordinate transformation and lighting. A system memory is allotted to the vertex shader of the add-on graphic card by a driver. After steps S64 and S65, determining all the vertex data is processed in step S66. If yes the procedure is finished, then continue to the following graphic processing by a clip and setup processor and a pixel shader in the integrated graphic chip. Otherwise go back to step S63, repeat the distribution of the vertex data. Herein the vertex shader of the add-on graphic card accesses vertex data through a PCI or a PCI Express interface to perform coordinate transformation and lighting. The vertex data is stored in the system memory after transformation and lighting. The vertex shader of the integrated graphic chip performs coordinate transformation and lighting on the vertex data by a CPU.

In an embodiment of the present invention the add-on graphic card includes a vertex shader implemented by hardware. The performance deficiency of the vertex shader due to computation on CPU can be improved with utilizing the existing clip and setup processor and the pixel shader in the integrated graphic chip, and the loading of CPU is reduced. Furthermore the cost can be reduced since the add-on graphic card has only the vertex shader. Another advantage of the graphic system in the present invention is that the vertex data is dynamically distributed to the vertex shaders according to the computation capability of the CPU and The add-on graphic card. The vertex shaders of the integrated graphic chip and the add-on graphic card are efficiently used and the vertex geometry computation speed of the graphic system is improved.

Although the preferred embodiment of the present invention is described in considerable detail, those with ordinary skills in the art should appreciate that they can readily use the disclosed conception and specific embodiments as a basis for designing or modifying other structures for carrying out the same purposes of the present invention without departing from the spirit and scope of the invention as defined by the appended claims.

What is claimed is:

1. A graphic system, comprising:
a first graphic device, comprising
a clip and setup processor for accessing and clipping a graphic data; and
a pixel shader for pixel shading said clipped graphic data; and
a second graphic device, removably disposed on said first graphic device which does not possess said clip and setup processor and said pixel shader, comprising:
a first vertex shader performing coordinate transformation and lighting on a vertex data to generate said graphic data.

2. The system of claim 1, wherein said first vertex shader outputs said graphic data to said first device for clipping and pixel shading.

3. The system of claim 1, wherein said first vertex shader accesses said vertex data through a bus.

4. The system of claim 1, wherein said first vertex shader accesses said vertex data from a system memory.

5. The system of claim 1, wherein said first vertex shader outputs said graphic data to a system memory.

6. The system of claim 1, wherein said first graphic device is an integrated graphic chip.

7. The system of claim 1, wherein said first graphic device further comprises a second vertex shader to perform coordinate transformation and lighting on said vertex data by a CPU.

8. The system of claim 1, further comprises a system BIOS to detect said second graphic device.

9. The system of claim 8, wherein said first vertex shader and said second vertex shaders access said vertex data according to the respective computation capability of said first vertex shader and said CPU and perform coordinate transformation and lighting to generate said graphic data when said system BIOS detects said second graphic device.

10. The system of claim 9, wherein said computation capability of said CPU is determined by a previous vertex computation record of said second vertex shader.

11. The system of claim 9, wherein said computation capability of said first vertex shader is determined by a previous vertex computation record of said vertex shader.

12. A graphic control method, for controlling a first graphic device and a second device, said first device comprises a first vertex shader and said second graphic device has a second vertex shader; said second vertex shader performs coordinate transformation and lighting on a vertex data by a CPU, the method comprises:
detecting said first graphic device;
distributing said vertex data by a driver to said first vertex shader and said second vertex shader if said first graphic device is detected; and
performing coordinate transformation and lighting on said vertex data by said first vertex shader to generate a graphic data.

13. The method of claim 12, further comprises clipping and pixel shading on said graphic data by said second graphic device.

14. The method of claim 12, wherein said first graphic device is disposed removably in said second graphic device.

15. The method of claim 12, wherein said driver dynamically distributes said vertex data to both or to either one of said first vertex shader and said second vertex shader.

16. The method of claim 12, wherein said step of distributing said vertex data by said driver further comprises distributing said vertex data to said first vertex shader and said second vertex shader according to the respective computation capability of said first vertex shader and said CPU.

17. The method of claim 16, wherein said computation capability of said first vertex shader in said first graphic device is determined by a previous vertex computation record of said first vertex shader.

18. The method of claim 16, wherein said computation capability of said CPU is determined by a previous vertex computation record of said second vertex shader.

19. The method of claim 12, wherein said vertex data is transmitted to said second graphic device if said first graphic device is not detected and coordinate transformation and lighting is performed by said second vertex shader to generate said graphic data.

20. The method of claim 12, wherein said first vertex shader accesses said vertex data through a bus.
